(19) United States
(12) Patent Application Publication
(10) Pub. No.: US 2019/0111586 A1
(43) Pub. Date: Apr. 18, 2019

(54) MULTI-PLASTIC AND NATURAL FIBER MATERIAL AND PROCESS FOR MANUFACTURING

(71) Applicant: Hon Man Hui, Carrollton, TX (US)

(72) Inventor: Hon Man Hui, Carrollton, TX (US)

(21) Appl. No.: 15/815,397

(22) Filed: Nov. 16, 2017

Related U.S. Application Data
(60) Provisional application No. 62/571,716, filed on Oct. 12, 2017.

(51) Int. Cl. B29B 17/04; C08J 11/06; B29B 17/02

(52) U.S. Cl. CPC B29B 17/0412; C08J 11/06; B29B 17/02; B29B 2017/0416; C08L 23/06; C08J 2323/04; C08J 2323/10; C08J 2467/02; B29B 2017/0258

(57) ABSTRACT

A method of plastic reclamation for a plastic and natural fiber mixture, comprising, forming a mixture off first plastic component, a second plastic component, a third fiber component and a fourth additive component, the first plastic component comprising polyethylene and polypropylene, the second plastic component comprising polyethylene terephthalate, polystyrene, acrylic, nylon, polycarbonate and bioplastic, wherein the first plastic component: comprises a larger weight percentage than the second plastic component and a sum of the first plastic component and the second plastic component is 10% to 95% of a total weight, the third fiber component comprising wood, paper and natural fiber, wherein its the third fiber component is 0% to 85% of the total weight and the fourth additive component comprising at least calcium carbonate and stabilizer, wherein the fourth additive component is 5% to 45% of the total weight, agglomerating the mixture, milling the mixture and granulating the mixture,

### BACKGROUND

### (1) Technical Field

The instant disclosure may be applicable to reclarmuion specifically composite plastic and fiber reclamation.

### (2) Background

The instant disclosure addresses composite plastic scrap which presently is difficult to reclaim such as mixed, contaminated, laminated, multilayer plastic, paper and combined natural fiber. The disclosure provides a possible solution for combined plastic and natural fiber scrap reclamation. Tho formulas are presented for the reclamation of wood plastic composite (WPC), multi-plastic and natural fiber composite (PNFC) and multi-plastic material (MPM) products.

### SUMMARY

In one embodiment a method of plastic reclamation for a plastic and natural fiber mixture, comprising at least one of forming a mixture of a first plastic component, a second plastic component, a third fiber component and a fourth additive component, wherein, the first plastic component comprising at least one of polyethylene and polypropylene, the second plastic component comprising at least one of polyethylene terephthalate, polystyrene, acrylic, nylon, polycarbonate and bioplastic, wherein the first plastic component comprises a larger weight percentage than the second plastic component and a sum of the first plastic component and the second plastic component is 10% to 95%, its of a total weight, the third fiber component comprising at least one of wood, paper and natural fiber, wherein the third fiber component: is 0% to 85% of the total weight and the ti urth additive component comprising at least calcium carbonate and stabilizer, wherein the fourth additive component is 5% to 45% of the total weight, agglomerating the mixture, milling the mixture and granulating the mixture,

In another embodiment a method of plastic reclamation for a plastic mixture, comprising at least one of, forming a mixture of a first plastic component, a second plastic component, a third plastic component, a fourth plastic component, a fifth plastic component and a sixth additive component, wherein, the first plastic component comprising at least one of polyethylene and polypropylene comprising at least 50% of the mixture by a total weight, the second plastic component comprising at least one of polyethylene terephthalate weighing up to 45% of the total weight, the third plastic component comprising at least one of high density polyethylene and low density polyethylene weighing up to 45% of the total weight, the fourth plastic component comprising polystyrene weighing up to 45% of the total weight, the filth plastic component comprising at least one of acrylic, nylon, polycarbonate and bioplastic weighing up to 45% of the total weight and the sixth additive component comprising at least calcium carbonate and stabilizer weighing up to 50% of the total weight, agglomerating the mixture, milling the mixture and granulating the mixture.

In a further embodiment a method of plastic reclamation for a plastic mixture, comprising: forming a mixture of a first plastic component, a second plastic, component and a third additive component, wherein, the first plastic component comprising, polypropylene comprising at least 50% of the mixture by a total weight, the second plastic component comprising at least one of acrylonitrile butadiene styrene, polystyrene, nylon, polycarbonate and bioplastic weighing, up to 45% of the total weight and the third additive component comprising at least calcium carbonate and stabilizer weighing between approximately 5% to 50% of the total weight, agglomerating the mixture, milling the mixture and granulating the mixture.

### DESCRIPTION OF THE DRAWINGS

FIG. 1 is a recovery system in accordance with one embodiment of the disclosure;

FIG. 2 is a shredder and grinder in accordance with one embodiment of the disclosure;

FIG. 3 is a film aggregator in accordance with one embodiment of the disclosure;

FIG. 4 is a pulverizer in accordance with one embodiment of the disclosure;

FIG. 5 is a mixer and storage hopper in accordance with one embodiment of the disclosure;

FIG. 6 is a dryer and infrared silo in accordance with one embodiment of the disclosure;

FIG. 7 is a mixer in accordance with one embodiment of the disclosure;

FIG. 8 is a hot-melt granulator in accordance with one embodiment of the disclosure;

FIG. 9 is a cooling air classifier in accordance with one embodiment of the disclosure;

FIG. 10 is a feeding and weighing station in accordance with one embodiment of the disclosure;

FIG. 11 is a reclamation machine in accordance with one embodiment of the disclosure;

FIG. 12 is a first method of reclamation in accordance with one embodiment of the disclosure; and

FIG. 13 is a second method of reclamation in accordance With one embodiment of the disclosure.

FIG. 14 is a third method of reclamation in accordance with one embodiment of the disclosure.

### DETAILED DESCRIPTION OF THE INVENTION

The embodiments listed below are written only to illustrate the applications of this apparatus and method, not to limit the scope. The equivalent form of modifications towards this apparatus and method shall be categorized as within the scope the claims.

The system of reclamation has two pans a recovery phase in which the portions are torn down in a multi-plastic recovery machine and a reclamation phase in which the torn down components are rebuilt to manufacture different types of reclaimed products.

Prior to reclamation, the plastic cattier is analyzed. The plastic carrier may be greater than 30% in the plastic scrap, and the plastic carrier melt temperature may be below 220 C. Engineering plastics and PVC polyvinyl chloride (PVC) may be greater than 40% of the plastic scrap with a plastic melting point temperature below 280 C.

The recovery is performed by a multi-plastic recovery machine which has a shredder and crusher, film agglomerate, a mill, a dryer silo, infrared silo, storage hopper system, a mixer, hot-melt granulator, air cooling system and feeding and weighing system. Optionally, the system may include a washing machine and plastic extruder for residential waste and commercial waste. These groups of machines are referred to as the multi-plastic recovery machine or the multi-plastic natural fiber (PNF) product. Another machine is used to recover the multi-plastic scrap with natural fiber and additives. The multi-plastic and natural fiber and multi-plastic processes are performed at low temperature.

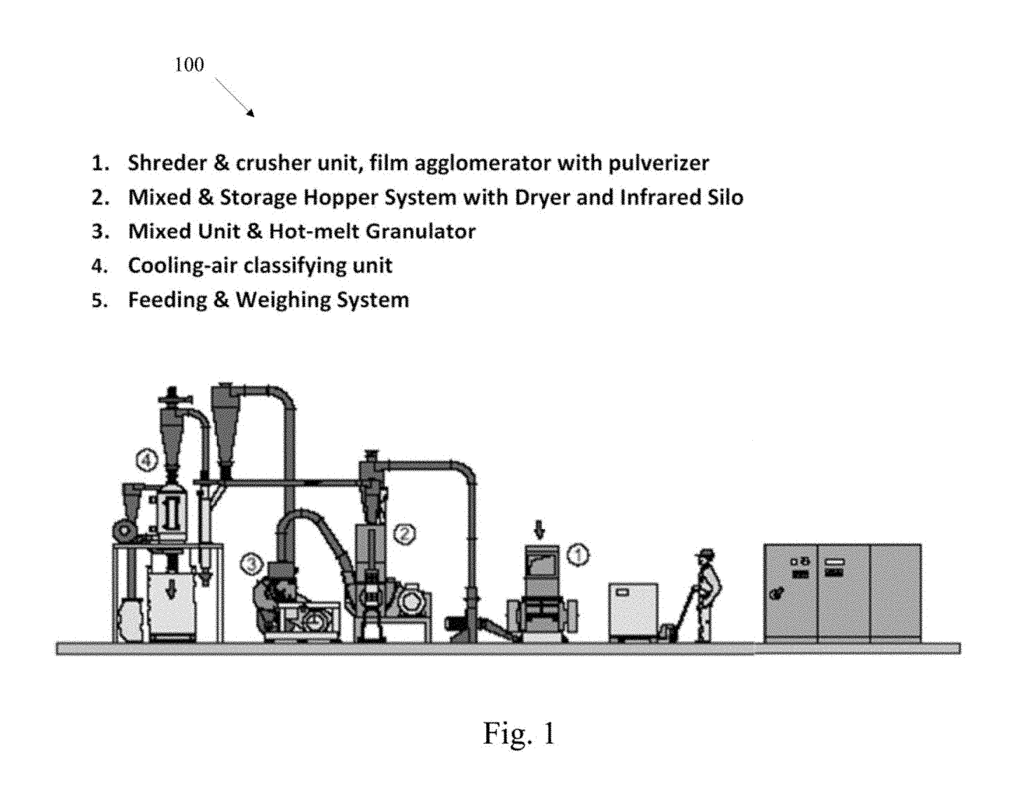

FIG. 1 depicts the recovery machine that may comprise the following,
1. Shreder and crusher unit, film agglomerator with pulverizer,
2. Mixed and Storage Hopper System with Dryer and infrared Silo,
3. Mixed Unit and Hot-melt Granulator,
4. Cooling-air classifying unit, and
5. Feeding and Weighing System.

Different incoming waste streams are treated differently for recovery, for the PNF multi-plastic and natural fiber, the incoming material can be processed in the following three examples.

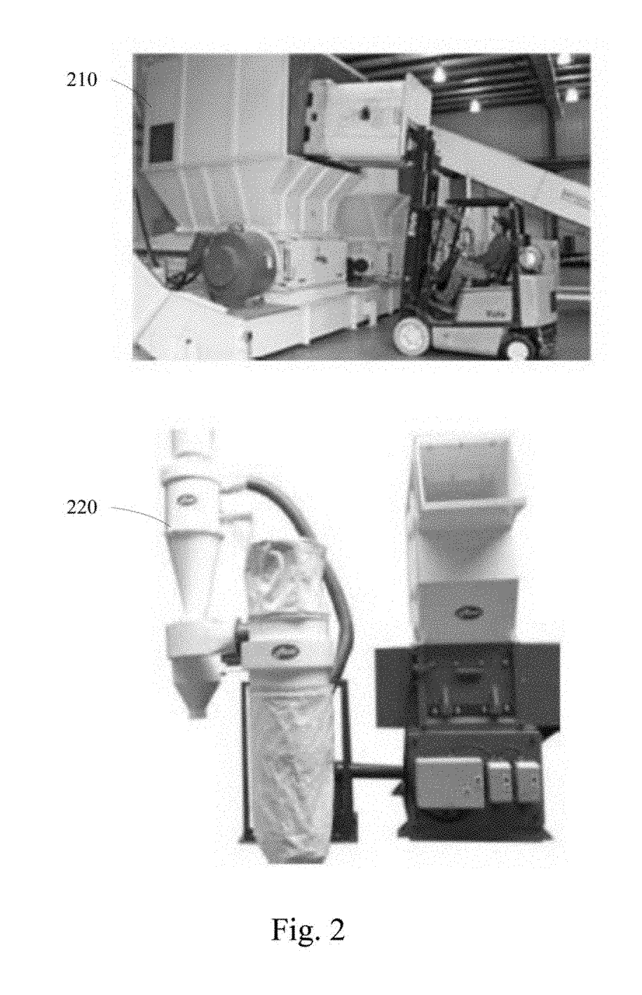

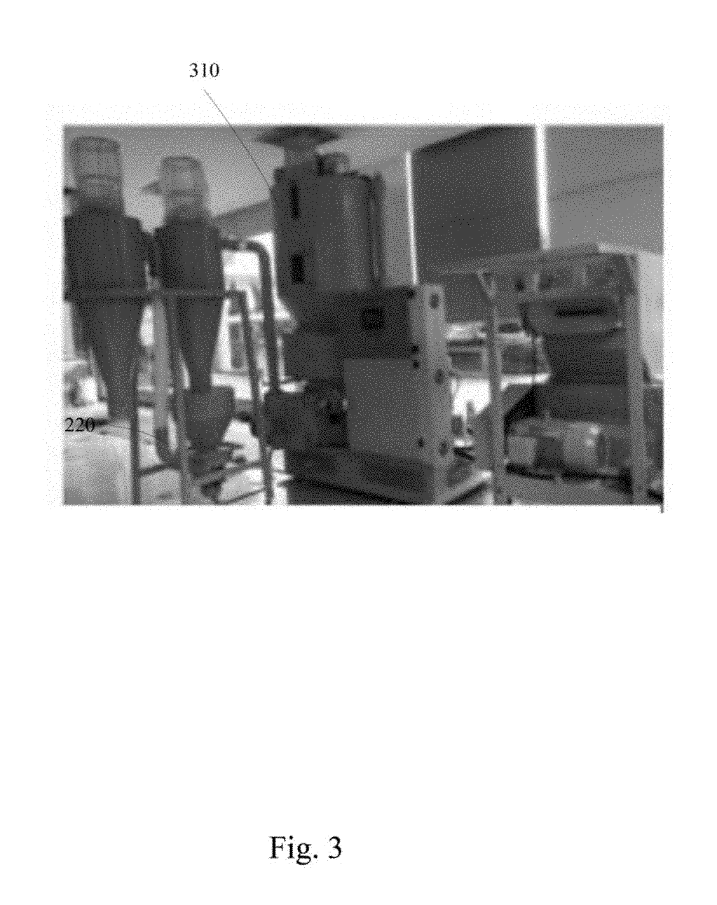

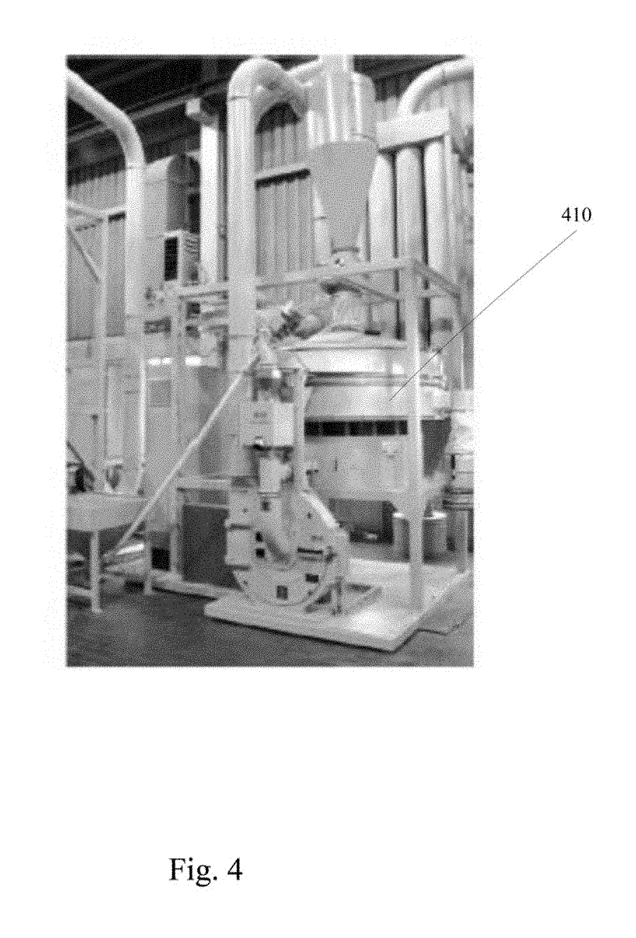

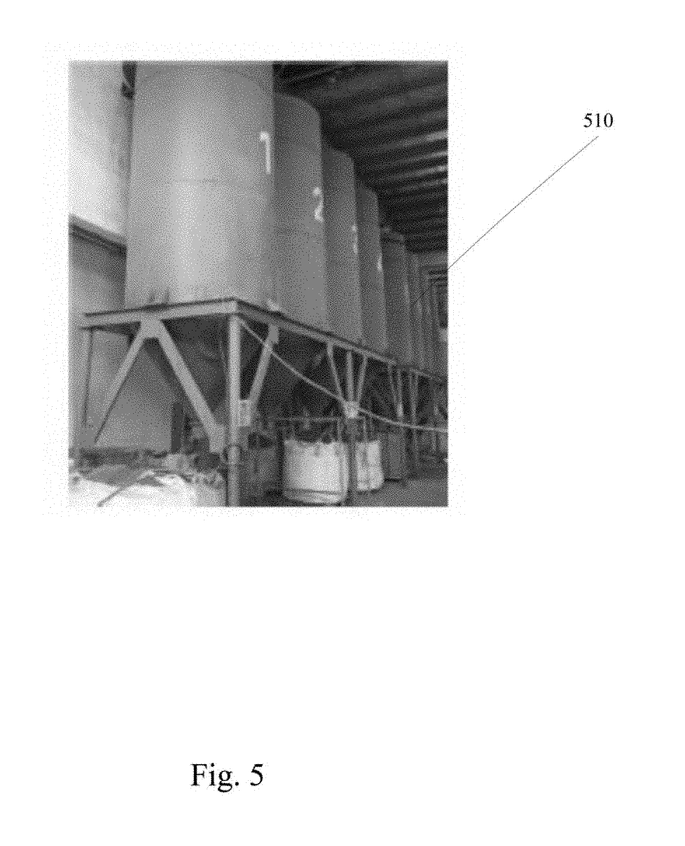

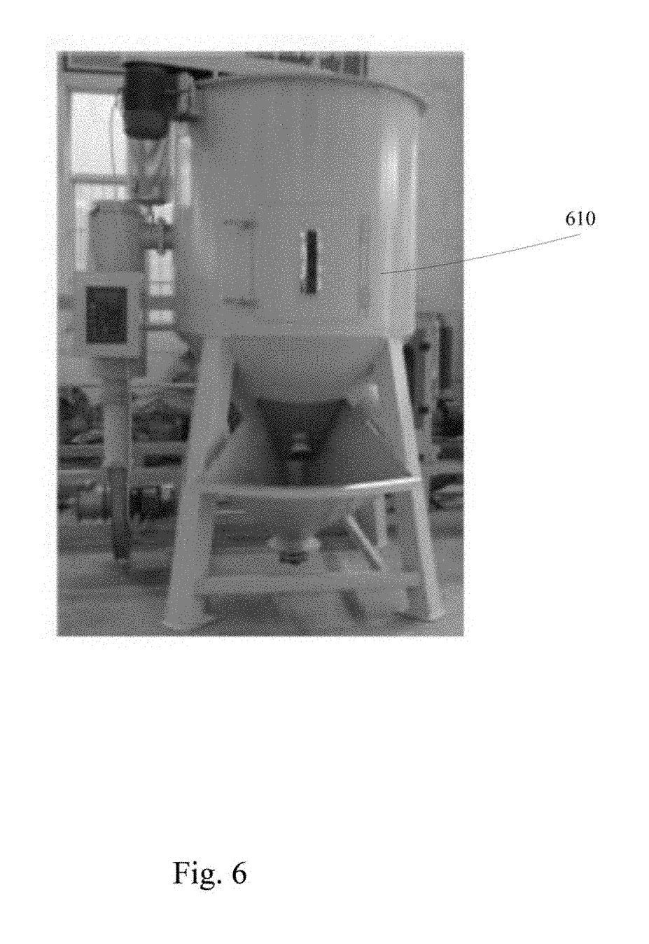

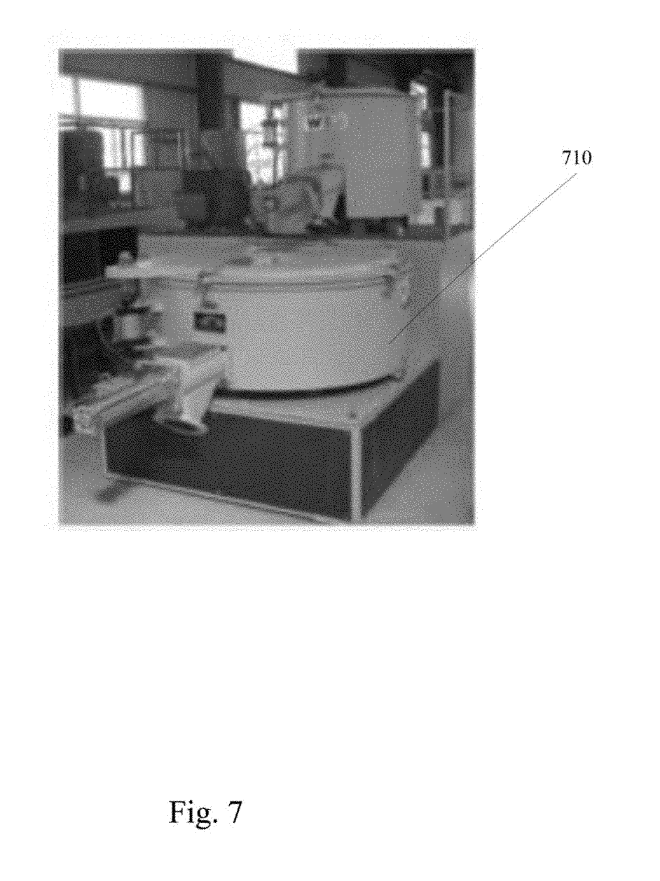

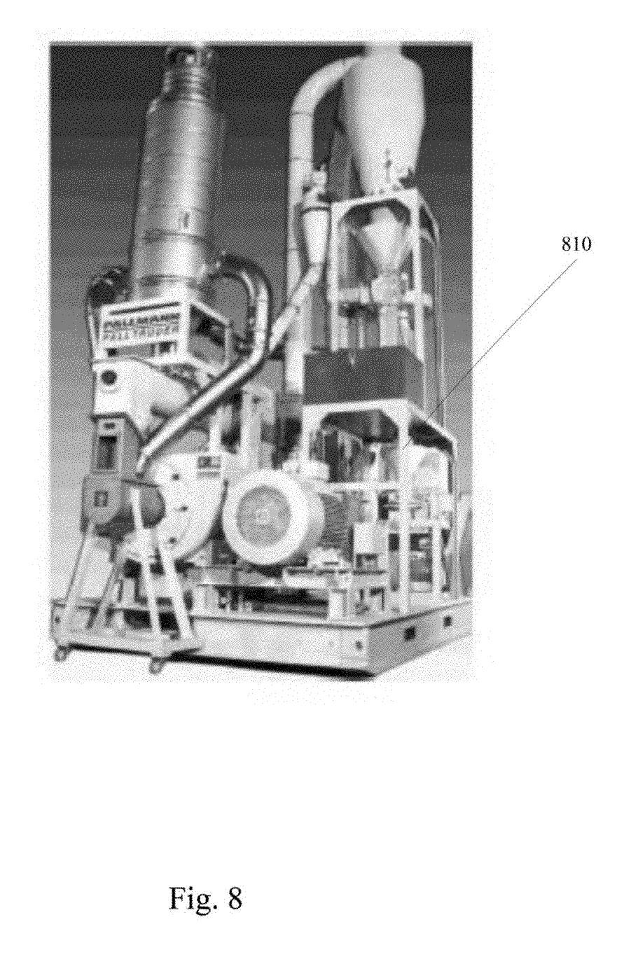

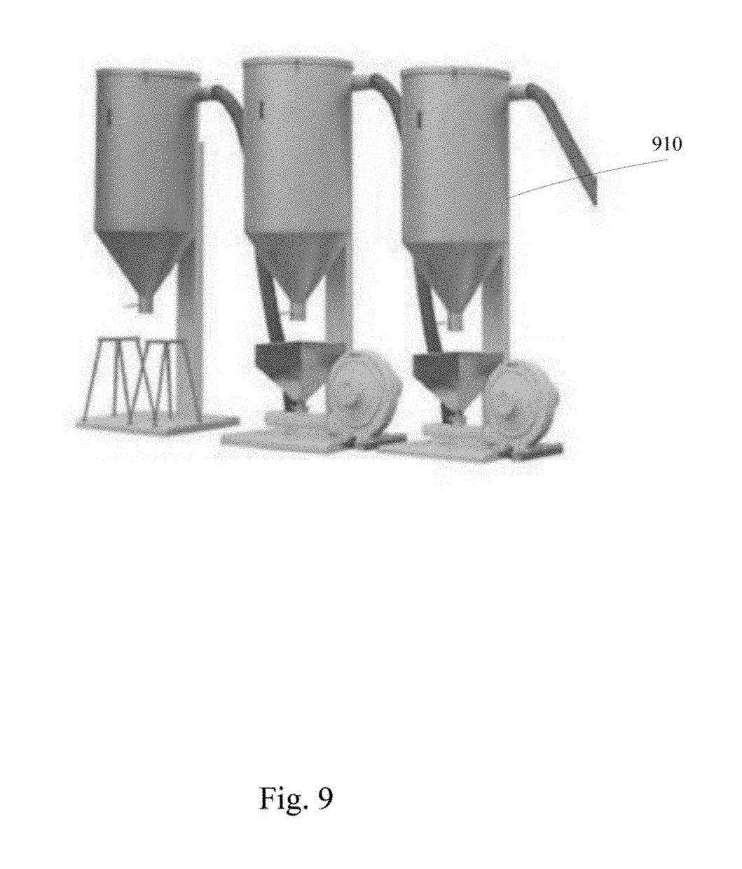

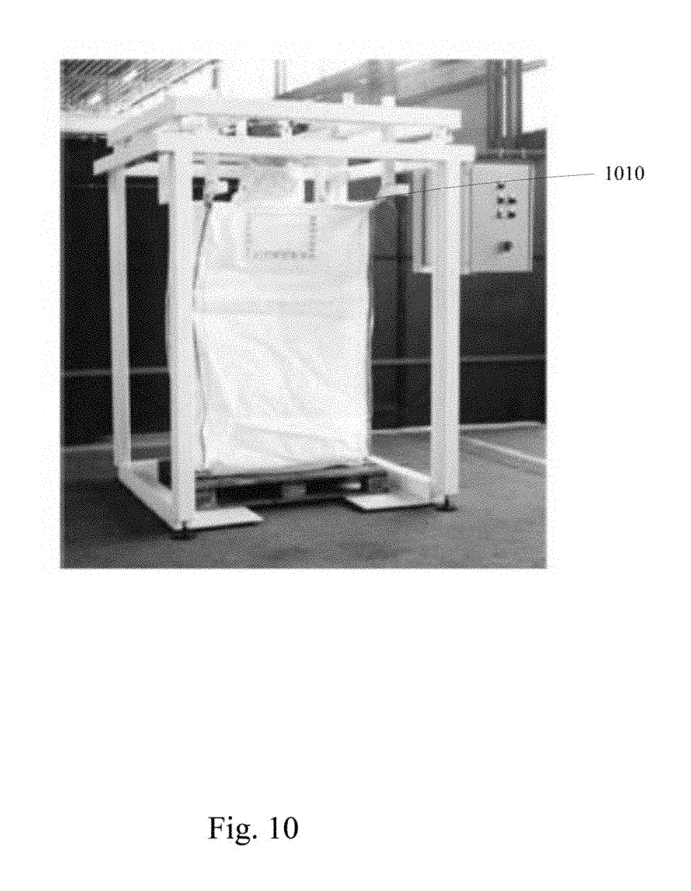

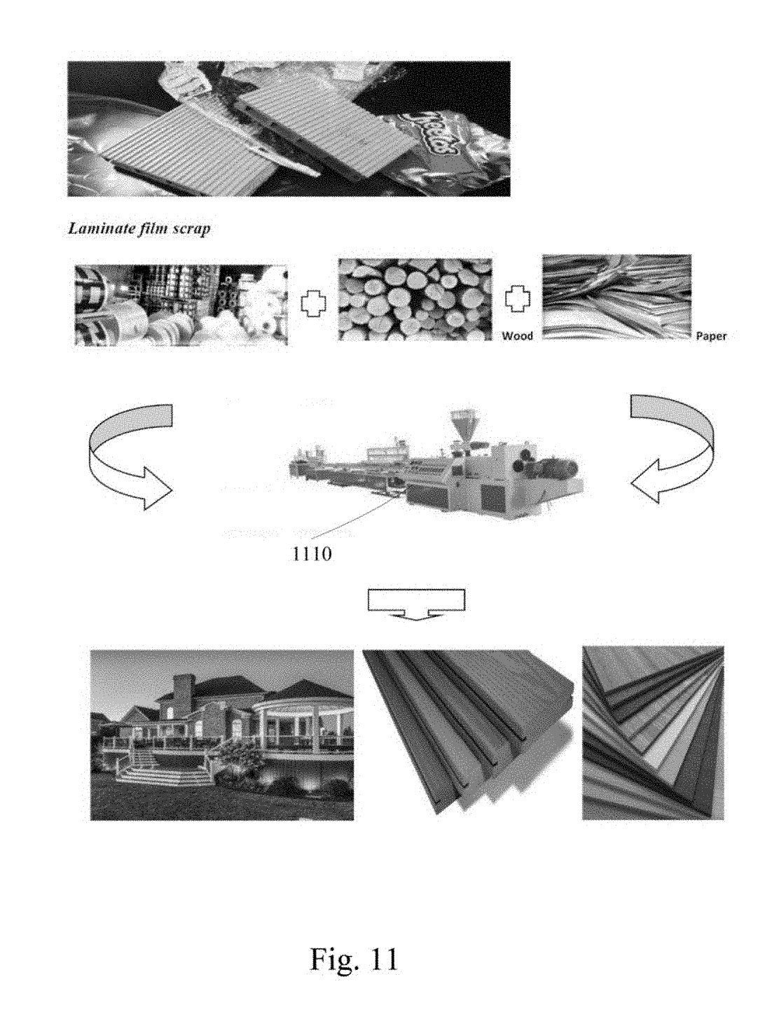

FIG. 2 depicts a shredder 210 and grinder 220 for shredding and grinding thick or large incoming plastic material into small pieces. FIG. 3 shows a film agglomerator 310, FIG. 4 depicts a pulverizer 41.0 to convert the small pieces into powder. FIG. 5 shows as mixer and storage hopper 510 evens out the powders. FIG. 6 depicts a dryer and infrared silo remove moisture and kill germs in the incoming material FIG. 7 shows a mixer for anther evening out the mixed materials and FIG. 8 depicts a hot melt granulator for congealing powders into pellets. FIG. 9 depicts a cooling air classifier cools down and classifies the incoming material and FIG. 10 depicts a feeding and weighing station. The general flow for breaking down the incoming materials is to go through a shredder and grinder, film agglomerator, pulverizer, mixer and storage hopper, dryer and infrared silo, its mixer, hot-melt granulator, cooling air classifier unit and feeding and weighing system. FIG. 11 depicts the reclamation machine 1110 having incoming laminated film scrap wood and paper and outputting a plastic wood composite material.

Food Packaging Program

The food packaging scrap program focuses on industrial film packaging which is laminated film and beverage packaging comprised of paper and plastic,

A film agglomerator is utilized to processes the different kinds of film and food packaging, laminated films and beverage packaging scrap at low temperature,

The plastic material and natural fiber material are mixed by the mixer and storage hopper to even out the material.

A mill is utilized to grind the plastic, wood, paper and natural fiber into different sizes of powder so that it may be used in different compound materials.

The powder is carried by a storage silo system to decrease pollution and ready the materials for formulation. The mixer is used to formula the multi-plastic, wood, paper and natural fiber and additive material.

A hot-melt granulator pelletizes the product, which improves the environmental conditions of the reclamation plant. The hot-melt granulator pelletizes the material.

The air cooling system is utilized to cool down the pellets of PNF material and the feeding and weighing system to pack the pellet in the Gaylord, bags, storage hopper, silo or container.

Products including wood will be made by the PNFC material and manufactured by a WPC Machine

Industrial Plastic Scrap Program

The shredder and grinder unit regrinds the larger plastic scrap which is then passed through a sorting line and a washing machine line if necessary.

The mill grinds the plastic, wood, paper and natural fiber to different sizes of powder to be used in different material compounds.

The powder is transported by the mixer and storage hopper system to decrease pollution, the mixer is set to a specific formula, based on the input materials and desired output materials.

The hot-melt granulator pelletizes the material to form a pelletized granulation of the materials.

An air cooler is used to air cool the pelletized material and a feeding and weighing system is used to pack the pellets into Gaylord, bags, storage hoppers, silos or containers,

Residential and Commercial Solid Waste Program

The solid waste runs on sorting line that separates the material.

A baler is used to processes the solid material to specific weights.

A washing machine is utilized on the incoming material if it is dirty.

A shredder and grinder unit regrinds thick and large plastic scrap.

The plastic material and natural fiber material is mixed by the mixer and storage hopper system to even out the material.

The film agglomerator is used to processes the different kinds of film or food packaging laminated films at low temperature.

The mill is used to grind the plastic, wood, paper and natural fiber into different sizes of powder for compounding.

The mix dryer silo, infrared silo system (Tempera re: 70 to 150 C) removes moisture and kills germs in the powder.

The powder is carried by the storage silo system to decrease air pollution.

The plastic extruder and hot-melt granulator pelletizes the material to also improve the plant environment.

The air cooling system is used to cool down the pelletized material and a feeding and weighing system is used to pack the pellets into Gaylords, bags, storage hoppers, silos or containers.

Summary of PNFC Process

First Step—Plastic is agglomerated by the agglomerator.

Second Step—The material is evenly mixed with the mixer and subsequently stored.

Third Step—The material is milled to grind it into a predetermined powder diameter.

Fourth Step—The material is mixed for a chosen plastic compound formulation.

Fifth Step—The powder is granulated using a hot-melt granulator.

New Plastic Material Description and Formula

The plastic material used in this formulation is 10%-70% polyethylenepolypropylenelpolyethylene terephthalate film grade scrap as the matrix carrier for different kinds of plastic. Added to this formulation is 25%-85% natural fiber with 5% additives. In this example the natural fiber is wood, paper, plant and textiles, The plastic film grade scrap for this polymer blend is polyethylene terephthalate, polyethylene, polypropylene and polystyrene where the plastics and natural fiber are mixed to produce multi-plastic, natural fiber and additive composites (PNF).

The agglomerator and mill processes the multi-plastic and natural fiber into powder. In this formula, #3—polyvinyl chloride May be less than 3% of the PNF material by weight.

The PNF powder may be dried in an infrared silo to disinfect the PNF powder before formulating in the mixer by mixer unit. The powder is pelletized in the hot-melt granulator and subsequently cooled the air cooling system. The formulations run at temperatures below the plastic melting point.

PNF Material Formula

PNF=(A)—Plastic {10% to 95%}+(B)—Natural Fiber {85% to 0%}+(C)—Additive {45%-5%} shown in FIG. 2, 2.10,

(A) is Polyethylene (PE) or Polypropylene (PP) film or blowing grade may make up 50% of the total weight of the matrix of the plastic scrap. The sub-plastic scrap may carry Polyethylene Terephthalate (PET), injection grade Polyethylene (PE), injection grade Polypropylene (PP), Polystyrene (PS) and other plastics (such as acrylic, nylon, polycarbonate, bioplastic and different plastics). These other plastics are the .minority members of the matrix making up less than 50% oldie total weight of the plastic material.

As a reference to the different plastic acronyms, the following is utilized, Polyethylene Terephthalate (PETE or PET), High-density Polyethylene (HDPE), Polyvinyl Chloride (PVC), Low-density Polyethylene (LDPE), Polypropylene (PP), and Polystyrene (PS).

(B) is Wood saw dust, wood flour and plants making up the matrix in the natural fiber. In this example up to 75% is natural fiber and up to 75% is paper scrap.

(C) is Additives make up to 45% of the weight of the matrix, the additives may be made up of 4%-40% calcium carbonate and 1%-45% stabilizer

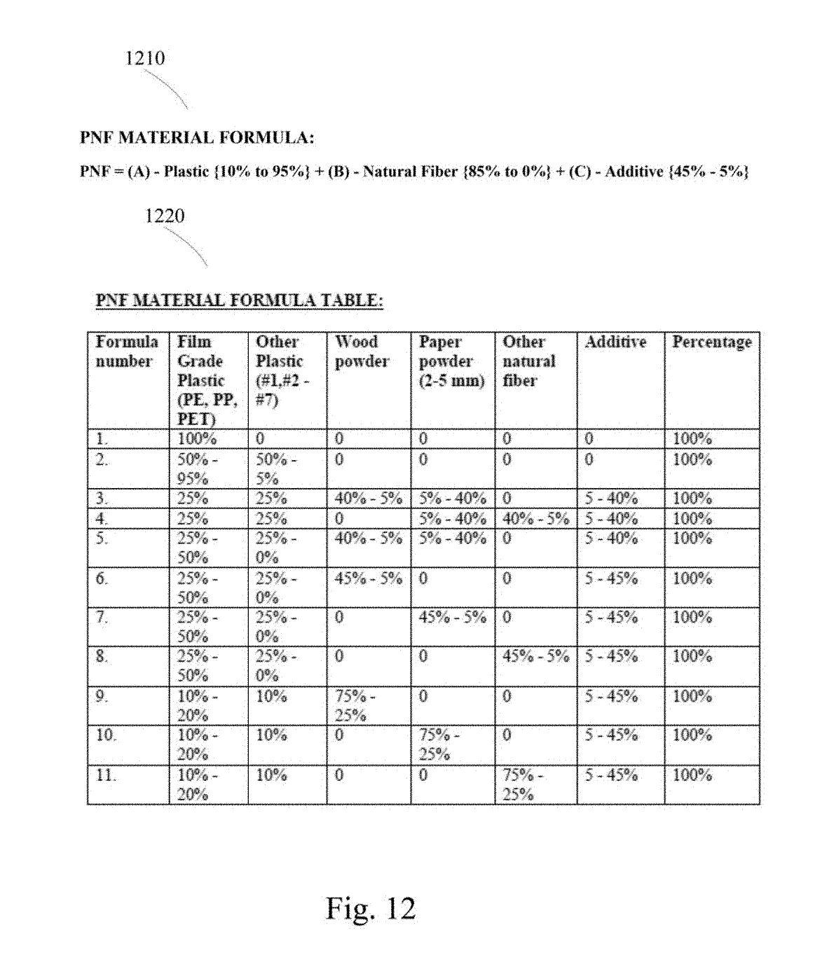

The various mixture formulas shown in FIG. 12, 1220.

A first example formula has the first plastic component comprising the total weight.

A second example formula has the first plastic component comprising 50% to 95% of the total weight and the second plastic component comprising 5% to 50% of the total weight.

A third example formula has he first plastic component comprising 25% of the total weida, the second plastic component comprising 25% of the total weight, the third fiber component is comprised of wood powder between 5% and 40% of the total weight and paper powder between 5% and 40% of the total weight and the fourth additive component comprises between 5% and 40% of the total weight.

A fourth example formula has the first plastic component comprising 25% of the total weight, the second plastic component comprising 25% of the total weight, the third fiber component is comprised of paper powder between 5% and 40% of the total weight and natural fiber between 5% and 40% of the total weight and the fourth additive component comprises between 5% and 40% of the total weight.

A filth example formula has the first plastic component comprising between 25% and 50% of the total weight, the second plastic component comprising up to 25% of the total weight, the third fiber component is comprised of wood powder between 5% and 40% of the total weight and paper powder between 5% and 40% of the total weight and the fourth additive component comprises between 5% and 40% of the total weight.

A sixth example formula has the first plastic component comprising between 25% and 50% of the total weight, the second plastic component comprising up to 25% of the total weight, the third fiber component is comprised of wood powder between 5% and 40% of the total weight and the fourth additive component comprises between 5% and 45% of the total weight.

A seventh example formula has the first plastic component comprising between 25% and 50% of the total weight, the second plastic component comprising up to 25% of the total weight, the third fiber component is comprised of paper powder between 5% and 40% of the total weight and the fourth additive component comprises between 5% and 45% of the total weight.

An eighth example formula has the first plastic component comprising between 25% and 50% of the total weight, the second plastic component comprising up to 25% of the total weight, the third fiber component is comprised of natural fiber between 5% and 40% of the total weight and the fourth additive component comprises between 5% and 45% of the total weight.

A ninth example formula has the first plastic component comprising between 10% and 20% of the total weight, the second plastic component comprising up to 10% of the total weight, the third fiber component is comprised of wood powder between 25% and 75% of the total weight and the fourth additive component comprises between 5% and 45% of the total weight.

A tenth example formula has the first plastic component comprising between 10% and 20% of the total weight, the second plastic component comprising up to 10% of the total weight, the third fiber component is comprised of paper powder between 25% and 75% of the total weight and the burth additive component comprises between 5% and 45% of the total weight.

An eleventh example formula has the first plastic component comprising between 10% and 20% of the total weight, the second plastic component comprising up to 10% of the total weight, the third fiber component is comprised of natural fiber between 25% and 75% of the total weight and the fourth additive component comprises between 5% and 45% of the total weight.

(MPM) Multi-Plastics Material First Formula not having Natural Fiber and Polyvinyl Chloride

MPM=(A−20% to 100%)+(B−45% to 0%)+(C−5% to 50%), shown in FIG. 3, 310.

(A) is Polyethylene (PE) or Polypropylene (1W) film or blowing grade may comprise 20%-100% of the plastic scrap.

(B) is secondary plastic scrap may comprise up to 45% of Poly-ethylene Terephthalate (PET or PETE), injection/film/blowing grade of Polyethylene (PE), injection/film/blowing grade of Polypropylene (PP), Polystyrene (PS) and other plastics such as Acrylonitrile butadiene styrene (ABS), Acrylic, nylon, polycarbonate and bioplastic,

(C) is additive that may make up to 45% of the matrix. The additives comprise primarily 4%-40% calcium carbonate and 1%-45% stabilizer.

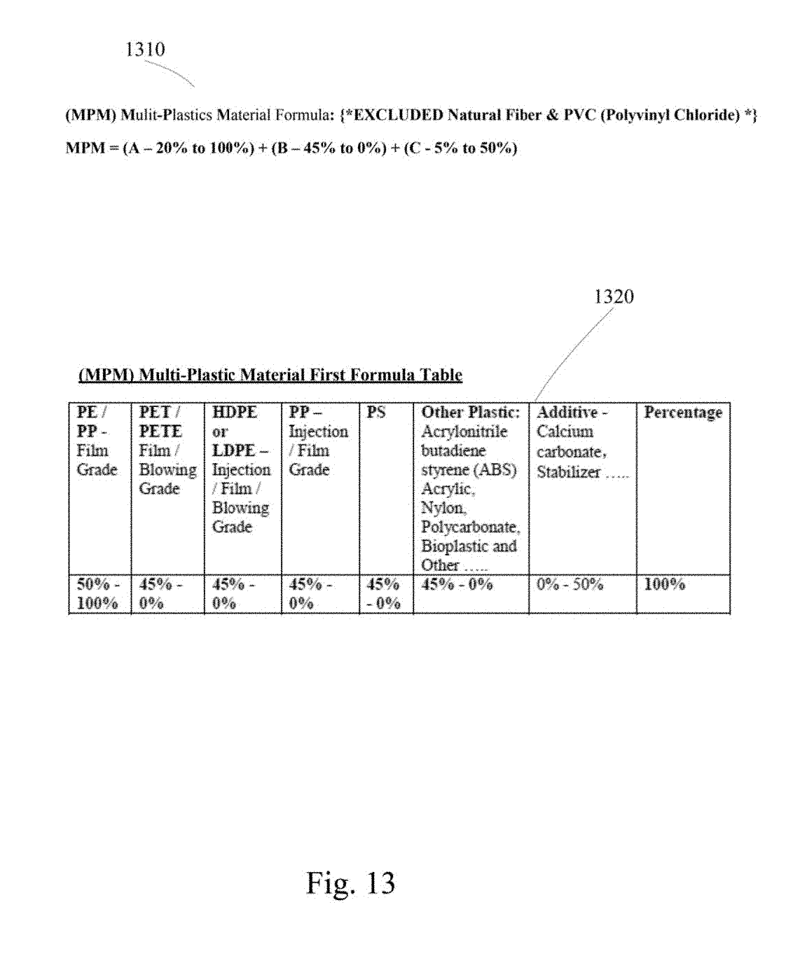

The first mixture tbrmula table is shown in FIG. 13, 1320.

(MPM) Multi-Plastics Material Second Formula not having Natural Fiber, Polyethylene and Polypropylene

MPM=(A−20% to 100%)+(B−45% to 0%)+(C−5% to 50%), shown in FIG. 3. 310.

(A) is polyvinylchloride (PVC) which may comprise 20%-100% of the plastic scrap.

(B) is secondary plastic scrap may comprise up to 45% of Polystyrene (PS) and other plastics such as Acrylonitrile Butadiene Styrene (ABS), acrylic, nylon, polycarbonate and bioplastic.

(C) is additive that may make up to 45% of the matrix. The additives comprise primarily 4%-40% calcium carbonate and 1%-45% stabilizer.

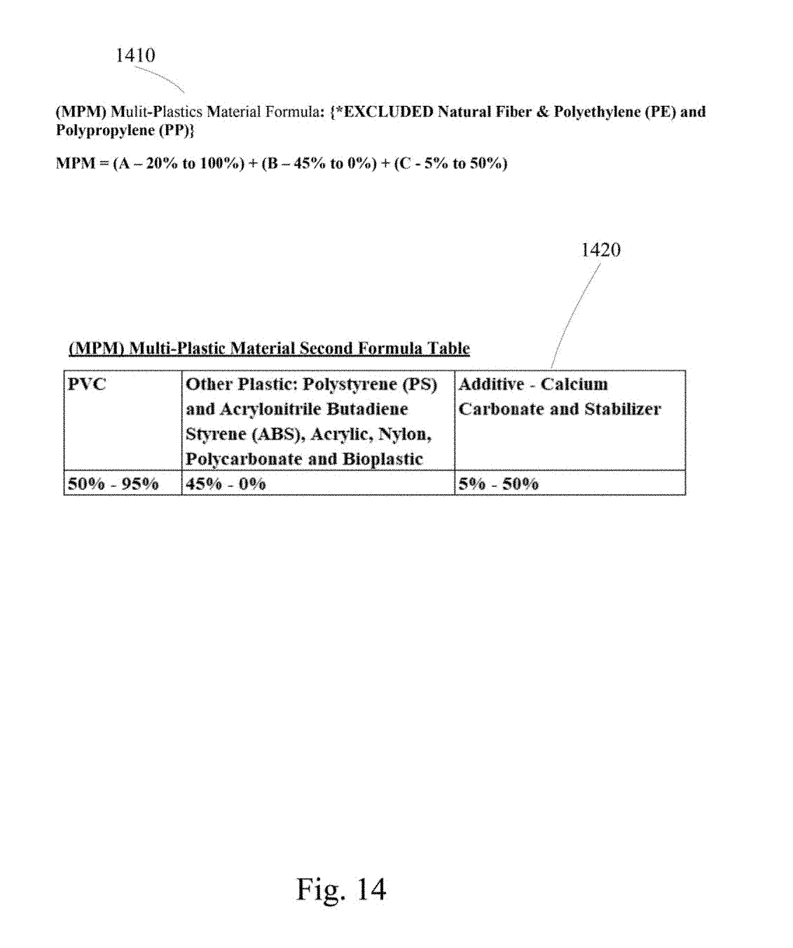

The second mixture formula table is shown in FIG. 14, 1420.

It is to be understood that various modifications may be made without departing from the spirit and scope of the invention. lt is to be understood that the foregoing description is intended to illustrate and not to limit the scope of the invention, which is defined by the scope its of the followim claims, and that other embodiments are within the scope of the claims.

What is claimed is:

1. A method of plastic reclamation for a plastic and. natural fiber InixIttre, comprising:
forming a mixture of a first plastic component, a second plastic component, a third fiber component and a fourth additive component, wherein,
the first plastic component comprising at least one of polyethylene and polypropylene.
the second plastic component comprising at least one of polyethylene terephthalate, polystyrene acrylic, nylon, polycarbonate and bioplastic,
wherein the first plastic component comprises a larger weight percentage than the second plastic component and a. sum of the first plastic component and the second, plastic component is 10% to 95% of a total weight,
the third fiber component comprising at least one of wood, paper and natural fiber, wherein the third fiber component is 0% to 85% of the total weight, and
the fourth additive component comprising at least calcium carbonate and stabilzer, wherein the fourth additive component is 5% to 45% of the total weight;
agglomerating the mix tare;
milling the mixture: and
granulating the mixture.

2. The method of claim 1 wherein,
the first plastic component comprises the tonal weight.

3. The method of claim 1 wherein,
the first plastic ponent comprises 50% to 95% of the total weight and
the second plastic component comprises 5% to 50% of the total weight.

4. The method of claim 1 wherein,
the first plastic component comprises 25% of the total weiirht,
the second plastic component comprises 25% of the total weight,
the third fiber component is comprised of wood powder between 5% and 40% of the total weigh(and paper powder between 5% and 40% of the total weight, and
the fourth additive component comprises between 5% and 40% of the total weight.

5. The method of claim I wherein,
the first plastic component comprises 25% of the total weight,
the second plastic component comprises 25% of the total veight,
the third fiber component is comprised of paper powder between 5% and 40% of the total weight and natural fiber between 5% and 40% of the total weight, and
the fourth additive component comprises between 5% and 40% of the total weight.

6. The method of claim 1 wherein.
the first plastic component comprises between 25% an td 50% of the total weight,
the second plastic component comprises up to 25% of the total weight,
the third fiber component is comprised of wood powder between 5% and 40% of the total weight and paper powder between 5% and 40% of the total weight, and
the fourth additive component comprises between 5% and 40% of the total weight,

7. The method of claim 1 wherein,
the first plastic component comprises between 25% and 50% of the total weight,
the second plastic component comprises up to 25% of the total weight,
the third fiber component is comprised of wood powder between 5% and 40% of the total weight, and
the fourth additive component comprises between 5% and 45% of the total weight.

8. The method of claim 1 wherein,
the first plastic component comprises between 25% and 50% of the total weight,
the second plastic component comprises up to 25% of the total weight,
the third fiber component is comprised of paper powder between 5% and 40% of the total wei2ht, and
the fourth additive component comprises between 5% and 45% of the total weight,

9. The method of claim 1 wherein,
the first plastic, component comprises between 25% and 50% of the total weight,
the second plastic component comprises up to 25% of the total weiaht,
the third fiber component is comprised of natural fiber between 5% and 40% of the otal weight, and
the fourth additive component comprises between 5% and 45% of the total weight.

10. The method of claim 1 wherein,
the first plastic component comprises between 10% and 20% of the total weight,
the second plastic component comprises up to 10% of the total weight,
the third fiber component s comprised of wood powder between 25% and 75% of the total weight, and
the fourth additive component comprises between 5% and 45% of the total weight,

11. The method of claim 1 wherein,
the first plastic component comprises between 10% and 20% of the total weight,
the second plastic component comprises up to 10% of the total weight,
the third fiber component is comprised of paper powder between 25% and 75% of the total weight, and
the fourth additive component comprises between 5% and 45% of the total weight.

12. The method of claim 1 wherein,
the first plastic component comprises between 10% and 20% of the total weight,
the second plastic component comprises up to 10% of the total weight,
the third fiber component is comprised of natural fiber between 25% and 75% of the total weight, and
the fourth additive component comprises between 5% and 45% of the total weight.

13. The method of claim 1 further comprising mixing the mixture.

14. The method of claim 1 wherein the granulation is a hot melt granulation.

15. The method of claim 1 further comprising cooling the granulation using an air cooler.

16. A method of plastic reclamation for a plastic mixture, comprising:
forming a mixture of a first plastic component, a second plastic component, a third plastic component, a fourth plastic component, a fifth plastic component at d a sixth additive component, wherein,
the first plastic component comprising at least one of polyethylene and polypropylene comprising at least 50% of the mixture by a total weight,
the second plastic component comprising at least one of polyethylene terephthalate weighing up to 45% of the total weight,
the third plastic component comprising at least one of high density polyethylene and low density polyethylene weighing up to 45% of the total weight,
the fourth plastic component comprising polystyrene weighing up to 45% of the total weight,
the fifth plastic component comprising at least one of acrylic, nylon, polycarbonate and bioplastic weighing up to 45% of the total weight., and
the sixth additive component comprising at least calcium carbonate and stabilizer weighing up to 50% of the total weight;
agglomerating the mixture;
milling, the mixture; and
granulating the mixture.

17. The method of claim 16 further comprising mixing the mixture.

18. The method of claim 16 wherein the granulation is a hot melt granulation.

19. The method of claim 16 further comprising cooling the granulation using an air cooler.

20. A method of plastic reclamation for a plastic mixture, comprising:
forming a mixture of a first plastic component, a second plastic component and a third additive component wherein,
the first plastic component comprising polypropylene comprising at least 50% of the mixture by a total weight,
the second plastic component comprising al least one of acrylonitrile butadiene styrene, polystyrene, nylon, polycarbonate and bioplastic weighing up to 45% of the total weight, and
the third additive component comprising at least calcium carbonate and stabilizer weighing between approximately 5% to 50% of the total weight;
agglomerating the mixture;
milling the mixture; and
granulating the mixture,
